(19) United States
(12) Patent Application Publication
(10) Pub. No.: US 2020/0261871 A1
(43) Pub. Date: Aug. 20, 2020

(54) MIXER FOR SYNTHETIC QUARTZ

(71) Applicant: Veegoo Technology Co., Ltd., Guangdong (CN)

(72) Inventors: Jianping QIU, Guangdong (CN); Gao He, Guangdong (CN); Qingguo Zhang, Guangdong (CN)

(73) Assignee: Veegoo Technology Co., Ltd.

(21) Appl. No.: 16/854,335

(22) Filed: Apr. 21, 2020

Related U.S. Application Data
(63) Continuation-in-part of application No. PCT/CN2018/077366, filed on Feb. 27, 2018.

(51) Int. Cl. B01F 7/00; B28C 7/10; B28C 5/12; B28C 5/14

(52) U.S. Cl. CPC B01F 7/00633; B28C 7/10; B01F 7/00308; B01F 2215/0047; B28C 5/1246; B28C 5/147; B01F 7/00325

(57) ABSTRACT

A mixer for synthetic quartz includes a mixing barrel (1), a power transmission system (2), a mixing system (3), and multiple material receiving receptacles (4). The power transmission system is provided above the mixing tank. The mixing system is provided inside the mixing tank. The power transmission system is used to drive the mixing system to move. An opening is arranged at each of two ends of the material receiving receptacle. The multiple material receiving receptacles (4) are arranged at a top portion of the mixing tank, and end portions of two adjacent material receiving receptacles are spaced apart from each other without contact there between. A resin experiences low flow resistance in the material receiving receptacle, and thus can fall smoothly without accumulating in the material receiving receptacle. Moreover, the material receiving receptacle can be cleaned easily.

The present application claims priority from and is a Track One PCT bypass continuation in part of PCT/CN2018/077366, filed Feb. 27, 2018 entitled Mixer For Synthetic Quartz by applicant Feizhou DENG, and by inventors harming QIU, Gao HE, and Qingguo ZHANG, now assigned to Veegoo Technology Co. Ltd., which was published as WO 2019/136804 Jul. 18, 2019 and claims priority from China application 201810034421.4 filed Jan. 15, 2018, the disclosure of which is incorporated herein by reference.

### TECHNICAL FIELD

The invention relates to the technical field of mixing machinery, in particular to an artificial quartz stone mixer.

### BACKGROUND FIELD

Artificial quartz stone has a hard texture (Mohs hardness 5-7) and a dense structure (density 2.5 g/cubic centimeter). It has the characteristics of wear resistance, pressure resistance, high temperature resistance, corrosion resistance and penetration resistance that other decorative materials cannot match. Artificial quartz stone is composed of more than 90% natural quartz and about 10% color material, resin and other additives that adjust adhesion, curing, etc.

At present, the commonly used mixers generally inject resin directly into the mixing tank, and the position of the injected resin is fixed. Therefore, the resin is often accumulated at a certain position at the bottom of the mixing tank, which is likely to cause uneven mixing effect and very low mixing efficiency. In order to solve this drawback, some mixing tanks are currently provided with an annular groove, and a plurality of outlet pipes are provided on the annular groove, and the resin directly falls into the annular groove. Then flows out from the outlet pipe, and then falls onto the powder. Thereby making the stirring, the effect is good. However, during the mixing process, a large amount of dust will be raised in the mixer, and the resin flows out from the outlet of the outlet pipe. Once the dust contacts the resin, it will stick to the resin, and it is easy to accumulate over the long-term and block the outlet of the outlet pipe. In addition, the installed outlet pipe needs to consider the installation position and installation direction in order to prevent interference with the mixing shaft, making the overall structure of the mixer more complicated, which is not conducive to installation and saving production costs. Moreover, after stirring, due to the structural limitation of the annular groove, it is difficult to completely discharge the resin in the annular groove into the outlet pipe, which easily leads to resin accumulation. Over time, the resin agglomerates which makes the flow of resin not smooth and affects production.

### SUMMARY OF INVENTION

The purpose of the present invention is to provide an artificial quartz stone mixer which is easy to clean at the receiving trough and has a small flow resistance of the resin falling in the receiving trough and a smooth resin dropping process in view of the shortcomings in the prior art.

To achieve this objective the present invention adopts the following technical solution: an artificial quartz stone mixer, including a mixing barrel, a power transmission system, a mixing system, and a multi-section receiving trough. The power transmission system is disposed above the mixing barrel. The mixing system is disposed in the mixing barrel, and the power transmission system is used to drive the motion of the mixing system. Both ends of the receiving trough are provided with gaps, multiple sections of the receiving trough are provided on the top of the mixing barrel, and the ends of the two adjacent receiving troughs are arranged at a distance so as not to contact each other. Preferably, during the stirring process, each section of the material receiving trough makes a circular movement around the central axis of the mixing barrel. The cross-sectional shape of the material receiving trough is an arc shape.

Preferably, the stirring system includes three sets of stirring mechanisms. The three sets of stirring mechanisms are arranged at equal intervals in the circumferential direction. The power transmission system is connected to three sets of the stirring mechanism, driving three sets of the stirring mechanism to realize rotation around its own central axis, and also driving three sets of the stirring mechanism to realize revolution around the central axis of the stirring barrel.

Preferably, the stirring mechanism includes a rotating shaft, multiple connecting rods and multiple stirring paddles. The power transmission system is connected to the rotating shaft, one of the ends of the plurality of connecting rods are all connected to the rotating shaft, and the plurality of connecting rods are arranged at equal intervals in the circumferential direction. The stirring paddle is connected to the connecting rod, and at least two stirring paddles are connected to each connecting rod.

Preferably, the connecting rods include at least a first rod, a second rod and a third rod. The length of the first rod is greater than the length of the second rod, and the length of the first rod is also greater than the length of the third rod. Preferably, each section of the material receiving trough is connected to the power transmission system. Each section of the receiving trough is set above each set of stirring mechanisms. The power transmission system drives each section of the receiving trough and each set of stirring mechanisms below it to make a circular movement around the central axis of the stirring barrel.

The length of the turning radius of each section of the receiving groove is greater than the length between the axis of each set of rotating shaft and the central axis of the mixing barrel; and the distance between the end of each section of the receiving trough and the axis of each set of rotating shaft are both greater than the length of the first rod. Preferably, the material receiving trough is an arc-shaped groove. Each section of the material receiving trough is located on the same circumferential plane. Preferably, it also includes a partition.

The partition plate is disposed below the power transmission system, and separates the inner space of the mixing barrel and the power transmission system from each other. Preferably, it also includes a sealing plate and a plurality of feeding tubes.

The power transmission system includes an electric motor and a transmission assembly. The power output end of the motor is connected to the power input end of the transmission assembly, and the power output end of the transmission assembly is connected to the material receiving trough and the rotating shaft. The motor is started, and power is transmitted through the transmission assembly for driving the rotating shaft to rotate around its own axis in self-rotation, and also driving the receiving trough and the rotating shaft to rotate around the central axis of the mixing barrel to start the revolution.

The sealing plate is sleeved on the top of the mixing tank, above the transmission assembly and the material receiving trough. After each feed pipe passes through the sealing plate, its lower end is respectively arranged above the material receiving groove, and its upper end is respectively connected with a funnel.

Preferably, it also includes a powder blocking channel and a dust removing device. During mixing, the raised powder in the mixing barrel is led out of the mixer through the powder blocking channel. The powder blocking channel is a channel enclosed by the upper powder guide frame and the lower powder guide frame. The upper powder-introduction frame includes an upper plate; an upper plate and an upper plate. The upper plate and the upper plate are arranged vertically. The upper plate is arranged horizontally, and the height of the upper plate is greater than that of the upper plate. The height of the three plates, one end of the upper two plates is connected to one end of the upper plate. The other end of the upper plate is connected to the transmission assembly, and the other end of the upper two plates is connected to one end of the upper three plates. The transmission assembly also drives the upper powder guide frame to rotate around the central axis of the mixing barrel.

The lower powder guide frame includes a lower plate and a lower two plates. The lower plate is arranged vertically. The lower two plates are arranged horizontally. The lower plate is arranged between the upper plate and the upper three plates. The top of the next plate is not in contact with the upper two boards. The lower two boards are disposed below the upper three boards, and the bottom end of the next plate is connected to one end of the lower two boards. The other end of the lower end is connected to the sealing plate.

The air extraction port of the dust removal device passes through the sealing plate, is arranged above the lower two plates, and is arranged between the lower plate and the upper three plates. The dust-removing device is an exhaust fan or an air pump, and the dust-removing device filters the powder material are lifted in the mixing barrel and pumped out of the mixer.

Beneficial effect of the present invention: The material receiving trough is an open and vacant space at the top, which is easier to clean than the pipeline used in the prior art, and has low flow resistance. Because the resin flows from both ends of the receiving tank, there is no obstruction such as the outlet pipe, so it is possible to avoid the dust from clogging the outlet of the outlet pipe and make the process of falling the resin smooth. Moreover, without the restriction of the outlet pipe, it is not necessary to consider the installation position and installation direction of the outlet pipe, completely avoiding the situation of mutual interference with the stirring mechanism, which is beneficial to the installation inside the mixer. Cost of production: in totality, the overall structure of the artificial quartz stone mixer is much simpler than the existing mixer, but the function will not be affected, which is conducive to reducing the customer's production costs and later maintenance costs.

### SUMMARY OF THE CLAIMS

An artificial quartz stone mixer has: a mixing barrel; a power transmission system; a mixing system; and a receiving trough. The receiving trough has a pair of open ends and is formed in sections. The power transmission system is arranged above the mixing barrel, and the mixing system is arranged on the mixing barrel. The power transmission system drives the movement of the mixing system. The receiving trough is mounted over the mixing barrel, and wherein adjacent sections of the receiving trough are connected. The open ends of feeding troughs are arranged at a distance so as not to contact each other.

Optionally, during the stirring process, each section of the receiving groove rotates around the central axis of the mixing barrel. The cross-sectional shape of the receiving groove is an arc shape. The stirring system includes three sets of stirring mechanisms. The three sets of the stirring mechanisms are arranged at equal intervals in a circumferential direction. The power transmission system is connected to the three sets of the stirring mechanism mechanisms to drive the three sets of stirring mechanisms to rotate around their respective central axis, and also drive the three sets of stirring mechanisms to revolve around the central axis of the mixing barrel. The stirring mechanism includes a rotating shaft, a plurality of connecting rods and a plurality stirring paddles. The power transmission system is connected to the rotating shaft. The plurality of connecting rods each have an end of the connecting rod connected to the rotating shaft, and wherein the plurality of the connecting rods are arranged at equal intervals in a circumferential direction. The stirring paddle is connected to the connecting rod, and at least two stirring paddles are connected to each connecting rod.

The plurality of connecting rods includes at least a first rod, a second rod, and a third rod. A length of the first rod is greater than that of a length of the second rod. The length of the first rod is also greater than a length of the third rod. The each material receiving trough section is connected to the power transmission system. Each section of the material receiving trough is arranged above each set of mixing mechanisms. Each receiving trough section is arranged above each set of mixing mechanisms. The power transmission system drives each receiving trough section and each set of stirring mechanisms under it to make a circular movement around the central axis of the stirring barrel. A turning radius of each receiving trough section is greater than a turning radius of each set of rotating shafts and greater than a mixing barrel radius, wherein the length between the central axis. A distance between the end of each receiving trough section and the turning radius of each set of rotating shafts is greater than the length of the first rod.

The material receiving trough is an arc-shaped groove. Each section of the material receiving trough is located on the same circumferential plane. The artificial quartz stone mixer also optionally has a partition plate. The partition plate is disposed below the power transmission system, and a space inside the mixing tank of the mixing tank is connected to the power transmission system separated from the mixing tank.

The artificial quartz stone mixer can also have a sealing plate and a plurality of feeding tubes. The power transmission system includes a motor and a transmission component. The power output end of the motor is connected to the transmission component of the power input end of the transmission assembly. The power output end of the transmission assembly is connected to the receiving groove and the rotating shaft. The transmission of the transmission assembly drives the rotating shaft to rotate around its own axis to achieve rotation, and also drives the material receiving tank and the rotating shaft to rotate around the central axis of the mixing tank to realize a revolving motion. The sealing plate is sleeved on the top of the mixing tank, above the transmission assembly and the material receiving tank. Each feeding tube is worn after passing through the sealing plate. The ends are respectively arranged above the material receiving troughs, and the upper ends are respectively connected with funnels.

A powder blocking channel and a dust removing device are in use during stirring. Risen or agitated airborne powder material in the mixing barrel is drawn out of the mixer through a powder blocking channel. The powder blocking channel is a channel enclosed by the upper powder frame and the lower powder frame. The upper powder frame includes a first upper plate, a second upper plate, and a third upper plate. The first upper plate and the third upper plate are arranged vertically. The second upper plate is arranged horizontally. The height of the first upper plate is greater than the height of the third upper plate. The second upper plate is connected to the first upper plate and the third upper plate. The transmission assembly also drives the upper powder frame to rotate around the central axis of the mixing barrel. The lower powder frame includes the first lower plate and the second lower board. The first lower plate is arranged vertically. The second lower plate is arranged horizontally. The first lower plate is arranged between first upper plate and the third upper plate. The upper powder frame does not contact the lower powder frame. The second lower plate is connected to the sealing plate and to the first lower board.

The dust removal device has a dust removal device suction line that passes through the sealing plate and has a dust removal device intake port which is mounted over the lower plate above the second lower plate, and set between the first lower plate and the third upper plate. The dust removal device is an exhaust fan or an air pump, and wherein the dust removal device filters the powder material raised in the mixing barrel and pumps it out of the mixer.

### BRIEF DESCRIPTION

The present invention will be further described below with reference to the drawings and embodiments.

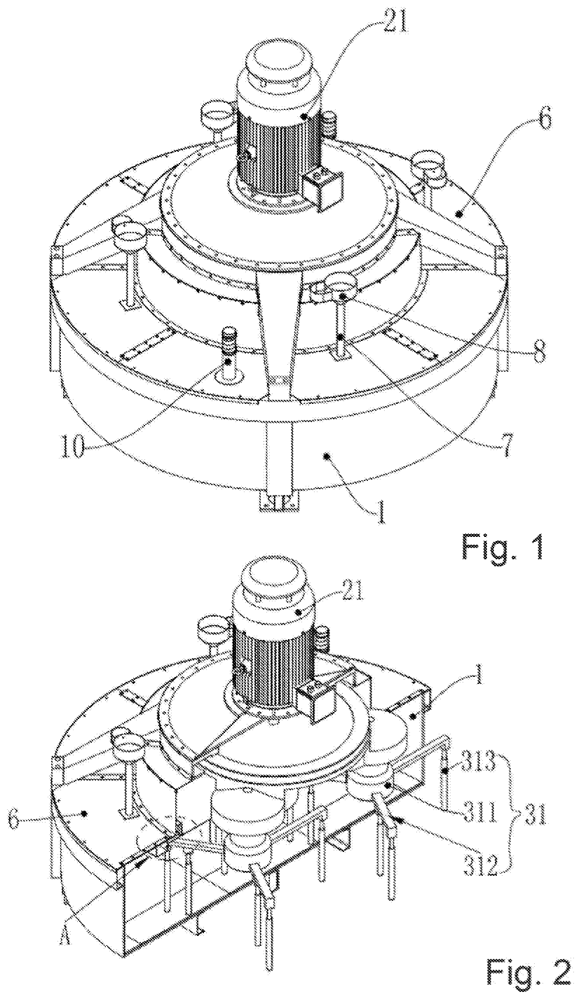

FIG. 1 is a schematic diagram of a three-dimensional structure of a mixer according to an embodiment of the present invention.

FIG. 2 is a schematic diagram of the internal structure of the mixing barrel in the mixer of the present invention.

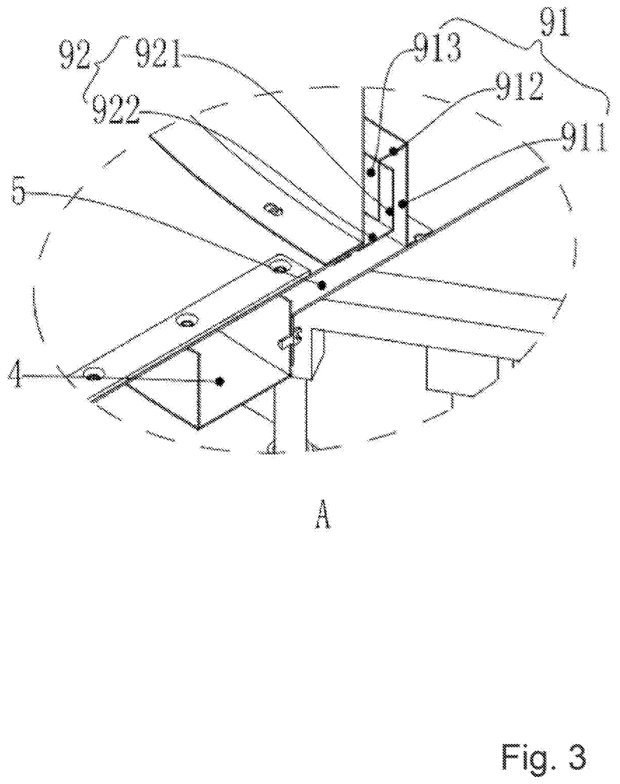

FIG. 3 is an enlarged schematic view of the structure at A in FIG. 2.

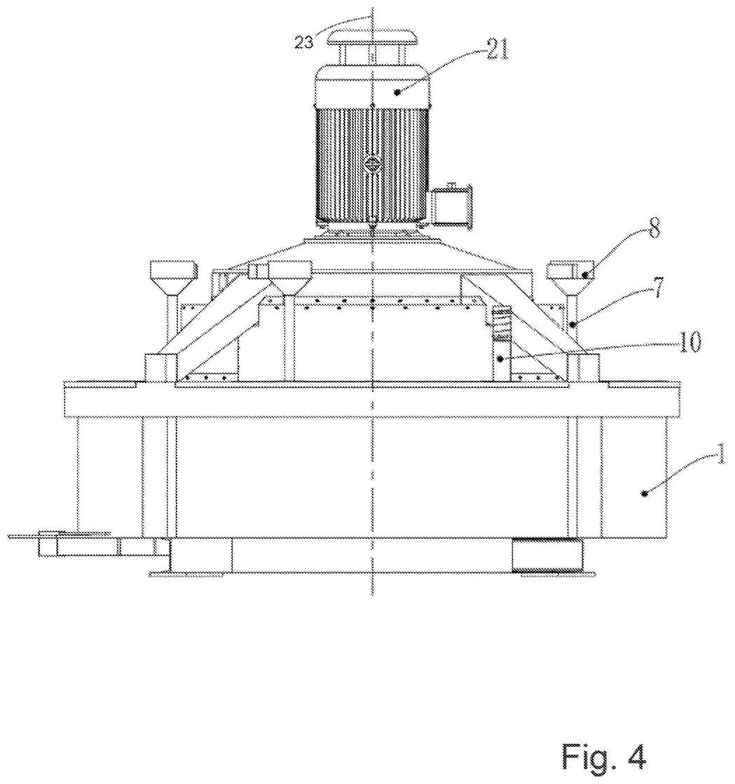

FIG. 4 is a front view of the mixer of one embodiment of the present invention.

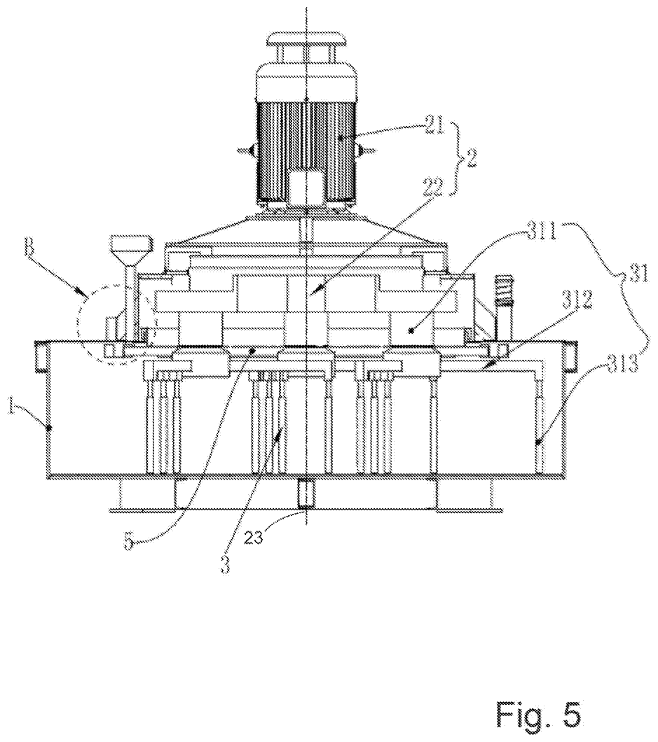

FIG. 5 is a schematic diagram of the internal cross-sectional structure of the mixing barrel in FIG. 4.

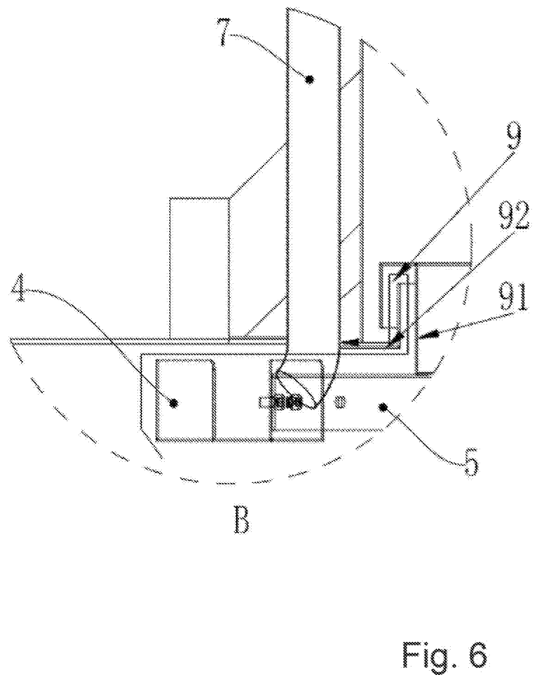

FIG. 6 is an enlarged cross section schematic view of the structure at B of FIG. 5,

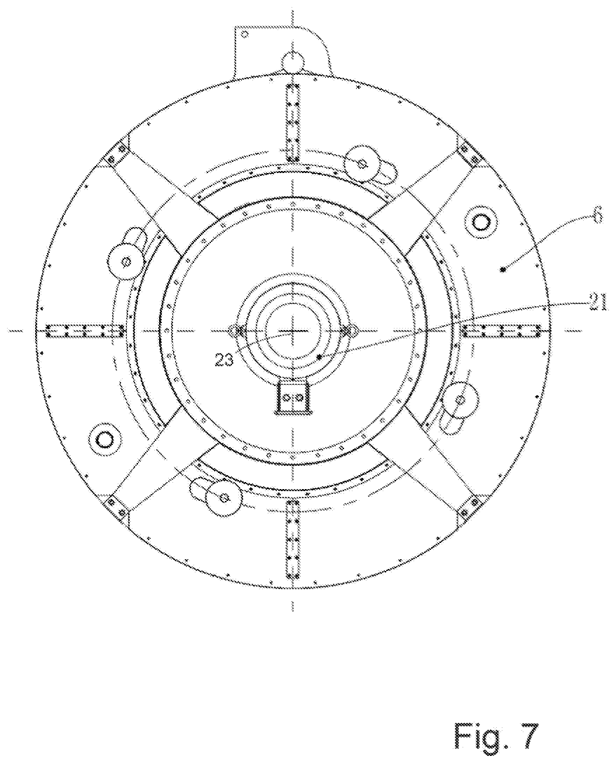

FIG. 7 is a top view of the mixer of one embodiment of the present invention,

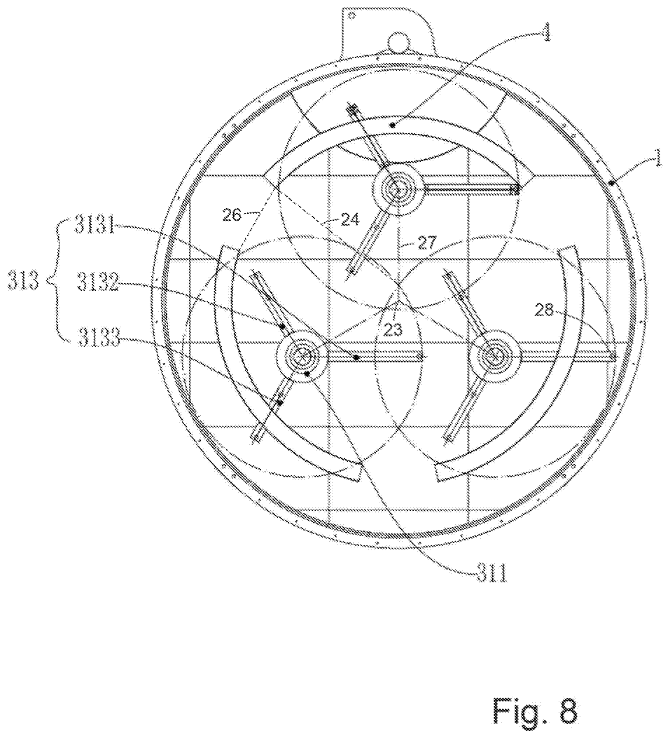

FIG. 8 is a schematic diagram of the internal cross-sectional structure of the mixing barrel in FIG. 7.

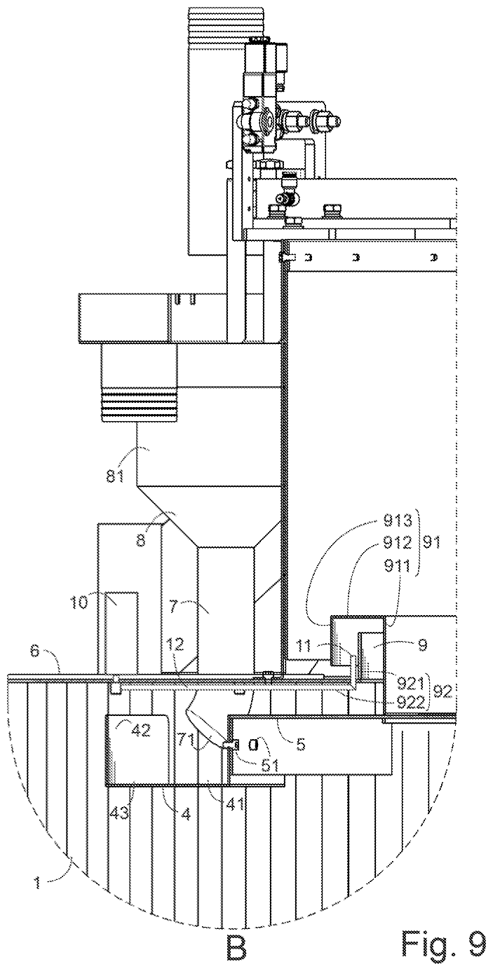

FIG. 9 is a detailed enlarged cross section schematic view of the structure at B of FIG. 5.

The following call out list of elements can be a useful guide in referencing the element numbers of the drawings.
1 Mixing barrel
2 Power Transmission System
3 Mixing System
4 Receiving Trough
41 Receiving Trough First Open End
42 Receiving Trough Vane
43 Receiving Trough Second Open End
5 Partition
51 Partition Bolts
6 Sealing Plate
7 Feeding Tube
71 Outwardly Bent Feeding Tube Lower End
8 Funnel
81 Hopper
10 Dust Removal Device
11 Dust Removal Device Intake Port
12 Dust Removal Device Suction Line
21 Electric Motor
22 Transmission Assembly
23 Central Axis Of The Stirring Barrel
24 Turning Radius Of Receiving Trough Section
26 Distance Between Ends Of Receiving Trough Sections
27 Rotating Shaft Set Turning Radius
28 length of turn radius of the first rod
31 Mixing Mechanism
311 Rotating Shaft
312 Connecting Rod
313 Mixing Paddle
9 Powder Channel
91 Upper Powder Frame
911 First Upper Plate
912 Second Upper Plate
913 Third Upper Plate
92 Lower Powder Frame
921 First Lower Board
922 Second Lower Board
3131 First Rod
3132 Second Rod
3133 Third Rod

### DETAILED DESCRIPTION

The technical solutions of the present invention will be further described below with reference to the drawings and through specific implementations.

An artificial quartz stone mixer, includes a mixing barrel 1, a power transmission system 2, a mixing system 3 and a multi-section receiving trough 4. The power transmission system 2 is disposed above the mixing barrel 1. The mixing system 3 is disposed in the mixing barrel 1, and the power transmission system 2 is used to drive the mixing system 3 to move. Both ends of the receiving trough 4 are provided with notches, and multiple sections of the receiving trough 4 are provided on the top of the mixing barrel 1, and the ends of the adjacent two sections of the receiving trough 4 are spaced apart and do not contact each other.

After injecting ceramic powder, color material, etc. into the mixing barrel 1. The power transmission system 2 is started, so that the power transmission system 2 drives the mixing system 3 to agitate the powder in the mixing barrel 1. During the mixing process, the resin is injected into the receiving trough 4 in multiple stages, and the resin falls directly into the mixing barrel 1 from both ends of the receiving trough 4 without any obstruction, and then is stirred together with the powder and color materials.

The receiving trough 4 is an open and vacant space at the top, which is easier to clean than the pipeline used in the prior art and has a low flow resistance. Since the resin flows out from both ends of the receiving trough 4 there is no obstruction such as the outlet pipe, so it is possible to avoid the dust from clogging the outlet of the outlet pipe and make the process of dropping the resin smooth. Moreover, without the restriction of the outlet pipe, it is not necessary to consider the installation position and installation direction of the outlet pipe, completely avoiding the interference with the stirring mechanism 31, which is conducive to the installation inside the mixer. On the other hand, without the outlet pipe, it can also save production costs. In addition, when the resin flows out from the two ends of the receiving trough 4, the resin is dropped between the multiple sections of the receiving trough 4, which can make the resin fall into the mixing barrel 1 with uniform distribution, which is convenient for mixing the resin and the powder, so that the mixing to raise efficiency.

Therefore, in totality, the overall structure of the artificial quartz stone mixer is much simpler than the existing mixer, but the function will not be affected, which is conducive to reducing the customer's production costs and later maintenance costs.

Furthermore, during the stirring process, each section of the material receiving trough 4 makes a circular motion around the central axis of the stirring barrel 1. The cross-sectional shape of the material receiving trough is an arc.

The receiving trough 4 can be formed as a trough that can enhance the fluidity of raw materials such as resin, so that they can quickly fall into the mixing barrel 1. During the mixing process the resin is continuously dropped from the two ends of the receiving trough 4 into the mixing barrel 1. Because the receiving trough 4 also moves in a circular motion, the resin that has not fallen in there is relative centrifugal movement so that the resin in the receiving trough 4 can be dropped quickly for an accelerated resin flow rate. On the other hand, after the mixer finishes stirring there will be no resin accumulated in the receiving trough 4, so it can prevent the resin from forming lumps thereby avoiding lumpy flow of resin. The receiving trough 4 may have a receiving trough first open end 41, FIG. 6 with a receiving trough vane 42, FIG. 6 for uniformly and quickly directing the spreading of the liquid phase resin. The receiving trough second open end 43 opposes the receiving trough first open end 41.

Furthermore, the stirring system 3 includes three sets of stirring mechanisms 31. Three sets of the stirring mechanisms 31 are arranged at equal intervals in the circumferential direction. The power transmission system 2 is connected to three sets of the stirring mechanism 31, which drives three sets of the stirring mechanism 31 to rotate around its own central axis, and also drives three sets of the stirring mechanism 31 to realize a revolution around the central axis of the mixing barrel 1.

Compared with the standard mixer with only two sets of mixing mechanisms, mixing powder efficiency is better than the standard mixer with only two sets of mixing mechanisms, because multiple sets of mixing mechanisms 31 can continuously stir up the powder, compared to the standard mixer with only two sets of mixing mechanisms, as there is always a part of the powder material that is stirred and then static and then stirred. In addition, in the same position in the mixing barrel 1, three sets of the stirring mechanism 31 can stir each position more times, increasing the probability that any location is stirred, so that the powder is stirred more uniformly.

Furthermore, the stirring mechanism 31 includes a rotating shaft 311, a plurality of connecting rods 312, and a plurality of stirring paddles 313. The power transmission system 2 is connected to the rotating shaft 311, one ends of the plurality of connecting rods 312 are connected to the rotating shaft 311, and the plurality of connecting rods 312 are arranged at equal intervals in the circumferential direction. The stirring paddle 313 is connected to the connecting rod 312, and at least two stirring paddles 313 are connected to each connecting rod 312.

During stirring, the power transmission system 2 drives the rotation shaft 311 to rotate around its own axis to realize the rotation motion, and the power transmission system 2 also drives the rotation shaft 311 to rotate about the central axis of the mixing barrel 1 to realize the orbital motion. In the process of rotation and revolution, multiple stirring paddles 313 continuously stir the powder in the mixing barrel 1, and at least 18 stirring paddles 313 constantly stir the powder, so it can stir the powder, resin and color more efficiently.

Furthermore, the plurality of connecting rods 312 includes at least a first rod 3131, a second rod 3132, and a third rod 3133. The length of the first rod 3131 is greater than the length of the second rod 3132, and the length of the first rod 3131 is also greater than the length of the third rod 3133. Each set of mixing mechanisms 31 includes at least three connecting rods 312, and the length of the first rod 3131 is the longest. During mixing, the entire mixing barrel 1 can be continuously stirred without dead angles or spaces, and the production capacity efficiency is increased by one hundred percent compared with traditional mixers.

When the longest first rod 3131 reaches the central axis of the mixing barrel 1, the shorter second rod 3132 and third rod 3133 of the other two sets of mixing mechanisms 31 are coordinated to reach near the central axis of the mixing barrel 1, so as to avoid interference of the three sets of stirring mechanism 31. If the three connecting rods were all the same length, any one of the agitating paddles 313 could not easily reach the position near the central axis of the agitating bucket 1, due to collision.

Furthermore, each section of the receiving trough 4 is connected to the power transmission system 2. Each section of the receiving trough 4 is respectively arranged above each set of stirring mechanism 31, The power transmission system 2 drives each section of the receiving trough 4 and each set of stirring mechanism 31 below it to work simultaneously around the central axis of the stirring barrel in a circular motion.

The length of the turning radius of each section of the receiving groove 4 is greater than the length between the axis of each set of rotating shaft 311 and the central axis of the mixing barrel 1. The distance between the axes is greater than the length of the first rod 3131.

The three-section receiving troughs 4 are three circumferentially uniform receiving troughs 4. Liquid raw materials such as resin fall into the trough first and then flow into the mixing barrel 1 from both ends of the trough, which can contaminate the connecting rod 312 with liquid raw materials. Once the resin drops onto the connecting rod 312, it will dry out after a period of time, and the dust raised in the mixing barrel 1 will also adhere to the resin, because the mixing barrel 1 is large and the structure is quite complicated. When cleaning, only manual cleaning is possible, which is quite troublesome. Therefore, the present invention quartz mixer can greatly reduce cleaning difficulty.

Furthermore, the material receiving trough 4 is an arc-shaped groove. Each section of the material receiving trough 4 is located on the same circumferential plane.

During the rotation of the receiving trough 4 driven by the power transmission system 2, the resin can be thrown out along one side of the receiving trough 4 toward both ends thereof, reducing the shaking of the resin in the receiving trough 4, making the resin flow smoothly. Moreover, the direction in which the resin falls is mostly toward the vicinity of the central axis of the mixing barrel 1, and hardly touches the wall of the mixing barrel 1, ensuring the cleanness of the wall of the tank.

Because the receiving trough 4 is performing centrifugal movement during rotation, if there is a section of the receiving trough 4 that is not on the same circumferential plane, then the respective receiving trough 4 has oblique forces generated during the rotation. This makes it difficult to balance the centrifugal force, and easy to misalign the rotating shaft 311, causing the rotating shaft 311 to be easily damaged. Therefore, when each section of the receiving groove 4 is located on the same circumferential plane, the force balance of the rotating shaft 311 can be ensured, to ensure that it rotates smoothly, so that the noise emitted by the mixer is reduced.

Furthermore, the artificial quartz stone mixer also includes a partition 5. The partition 5 is disposed below the power transmission system 2 to separate the inner space of the mixing barrel 1 and the power transmission system 2 from each other. During the mixing process, it is difficult for the mixing barrel 1 to enter the power transmission system 2, which is beneficial to reduce maintenance time and maintenance costs, reduce vibration and noise due to wear of gear sets and other structures, and can extend the power transmission system accordingly 2 lifespan.

Furthermore, the artificial quartz stone mixer also includes a sealing plate 6 and a plurality of feed tubes 7. The power transmission system 2 includes an electric motor 21 and a transmission assembly 22. The power output end of the electric motor 21 is connected to the power input end of the transmission assembly 22, and the power output end of the transmission assembly 22 is connected to the material receiving trough 4 and the rotating shaft 311, The transmission of the transmission assembly 22 drives the rotating shaft 311 to rotate around its own axis to achieve rotation, and also drives the receiving trough 4 and the rotating shaft 311 to rotate around the central axis of the mixing barrel 1 to achieve a revolution.

The sealing plate 6 is sleeved on the top of the mixing barrel 1, above the transmission assembly 22 and the receiving trough 4. After each feeding tube 7 passes through the sealing plate 6, its lower end is respectively disposed above the material receiving trough 4, and its upper end is respectively connected with a funnel 8, The funnel 8 is preferably fed by a hopper 81, The funnel 8 connects the hopper 81 to the feeding tube 7. The feeding tube has a lower end that has a slight outwardly bend. The outwardly bent feeding tube lower end 71 may have a circular opening.

The transmission assembly 22 can be a mechanical structure such as a gear set, and the sealing plate 6 can prevent the dust from being exposed when agitating the powder in the mixing barrel 1, so that a closed mixing space is formed in the mixing barrel 1, but even if the transmission assembly 22 is also wrapped by the sealing plate 6 and blocked by the partition plate 5, dust will not enter the transmission assembly 22, nor will it enter the motor 21. The operator can pour the resin from the funnel 8, and then the resin flows into the receiving trough 4 through the feeding tube 7. The position of the pour and the position of the stirring are completely separated by the sealing plate 6, which is convenient for pour. In addition, the funnel 8 can also be easily receive poured resin.

Furthermore, the artificial quartz stone mixer also includes powder blocking channel 9 and dust removal device 10 which can be a vacuum. During mixing, the raised powder in the mixing barrel 1 leads out of the mixer through the powder blocking channel 9. The powder blocking channel 9 is a channel enclosed by the upper powder guide frame 91 and the lower powder guide frame 92. The upper powder guide frame 91 includes a first upper plate 911, a second upper plate 912, and a third upper plate 913. The first upper plate 911 and the third upper plate 913 are both vertically arranged. The second upper plate 912 is horizontally arranged, and the height of the first upper plate 911 is greater than the height of the third upper plate 913. One upper end of the second plate 912 is connected to one upper end of the first upper plate 911, and the other end of the upper plate 911 is connected to the transmission assembly 22. The other end of the second upper plate 912 is connected to one end of the third upper plate 913. The transmission assembly 22 also drives the upper powder guide frame 91 to rotate around the central axis of the mixing barrel 1.

The lower powder guide frame 92 includes a first lower plate 921 and a second lower plate 922. The lower plate 921 is vertically arranged. The second lower plate 922 is horizontally arranged. The first lower plate 921 is arranged on the upper plate between the first upper plate 911 and the upper three plates 913. The top of the lower plate 921 does not contact the upper second plate 912. The second lower plate 922 is disposed below the third upper plate 913, and the bottom of the first lower plate 921. The end is connected to one end of the second lower plate 922, and the other end of the lower end is connected to the sealing plate 6.

The intake port 11 of the dust removal device 10 passes through the sealing plate 6 and is disposed above the lower second plate 922 and between the lower plate 921 and the upper three plates 913. The dust removal device 10 is an exhaust fan or an air pump, and the dust removal device 10 filters the powder material lifted in the mixing barrel 1 and filters it out of the mixer. The dust removal device 10 can be mounted on an upper outside surface of the sealing plate 6 and a dust removal device suction line 12 can pass through the sealing plate 6 and be mounted on the upper inside surface of the sealing plate 6. The dust removal device suction line 12 terminate at a dust removal device intake port 11 which can be placed in the powder channel 9.

During the mixing process, the dust raised in the mixing barrel 1 can be pumped out through the powder blocking channel 9, firstly above the receiving trough 4, and then above the partition 5. The dust is blocked by the upper two plates 912 and can fall to the upper side of the partition 5 accordingly, so as to limit the transitional discharge of dust and prevent pollution of the operating environment outside the mixer. The powder blocking channel 9 provides a serpentine path for the dust to exit which causes the dust to settle instead of flying out.

Optionally, the receiving trough 4 rotates relative to the feeding tube 7, which is fixed to the sealing plate 6. The receiving trough 4 can be rigidly connected to the partition 5 which can be mounted to the upper powder frame 91. As the upper powder frame 91 rotates relative to the powder frame 92, a dust removing device 10 can further remove the dust in the powder blocking passage 9 so that the gas discharged from the mixer does not contain large particles of dust, ensuring an excellent air environment in the operating space. The receiving trough 4 can be bolted to the partition 5 by partition bolts 51.

As seen in FIG. 8, three receiving trough sections of a receiving trough are positioned at 120° from each other and each of the three receiving trough sections have a pair of open ends. The receiving trough sections are connected to each other via a frame. For three receiving trough sections, there are a total of six open ends.

The geometry of the configuration is improved in operation when maintaining certain relationships between the dimensions of key elements: the central axis of the stirring barrel 23, the turning radius of the receiving trough section 24, the distance between ends of receiving trough sections 26, the rotating shaft set turning radius 27, and the length of the turn radius of the first rod 28. The best mode dimensions are described above.

The above content is only a preferred embodiment of the present invention. For those of ordinary skill in the art, according to the idea of the present invention, there may be changes in the specific implementation and application scope, and the content of this specification should not be understood as limitations thereof.

1. An artificial quartz stone mixer, comprising:
a. a mixing barrel;
b. a power transmission system;
c. a mixing system; and
d. a receiving trough, wherein the receiving trough has a pair of open ends and is formed in sections, wherein the power transmission system is arranged above the mixing barrel, and the mixing system is arranged on the mixing barrel, wherein the power transmission system drives the movement of the mixing system, wherein the receiving trough is mounted over the mixing barrel, and wherein adjacent sections of the receiving trough are connected, wherein the open ends of feeding troughs are arranged at a distance so as not to contact each other.

2. The artificial quartz stone mixer of claim 1, wherein during the stirring process, each section of the receiving groove rotates around the central axis of the mixing barrel, wherein the cross-sectional shape of the receiving groove is an arc shape.

3. The artificial quartz stone mixer of claim 1, wherein the stirring system includes three sets of stirring mechanisms, wherein the three sets of the stirring mechanisms are arranged at equal intervals in a circumferential direction, wherein the power transmission system is connected to the three sets of the stirring mechanism mechanisms to drive the three sets of stirring mechanisms to rotate around their respective central axis, and also drive the three sets of stirring mechanisms to revolve around the central axis of the mixing barrel.

4. The artificial quartz stone mixer of claim 3, wherein the stirring mechanism includes a rotating shaft, a plurality of connecting rods and a plurality of stirring paddles, wherein the power transmission system is connected to the rotating shaft, wherein the plurality of connecting rods each have an end of the connecting rod connected to the rotating shaft, and wherein the plurality of the connecting rods are arranged at equal intervals in a circumferential direction, wherein the stirring paddle is connected to the connecting rod, and at least two stirring paddles are connected to each connecting rod.

5. The artificial quartz stone mixer of claim 4, wherein the plurality of connecting rods include at least a first rod, a second rod, and a third rod, wherein a length of the first rod is greater than that of a length of the second rod, wherein the length of the first rod is also greater than a length of the third rod.

6. The artificial quartz stone mixer of claim 5, wherein each section of a material receiving trough is connected to the power transmission system; wherein each receiving trough section is arranged above each set of mixing mechanisms, wherein the power transmission system drives each receiving trough section and each set of stirring mechanisms under it to make a circular movement around the central axis of the stirring barrel, wherein a turning radius of each receiving trough section is greater than a turning radius of each set of rotating shafts and greater than a mixing barrel radius; and wherein a distance between the end of each receiving trough section and the turning radius of each set of rotating shafts is greater than the length of the first rod.

7. The artificial quartz stone mixer of claim 1, wherein the material receiving trough is an arc-shaped groove; wherein each section of the material receiving trough is located on the same circumferential plane.

8. The artificial quartz stone mixer of claim 1, further comprising: a partition plate, wherein the partition plate is disposed below the power transmission system, and the material receiving trough is connected to the power transmission system, which is separated from the mixing tank.

9. The artificial quartz stone mixer of claim 6, further comprising: a sealing plate and a plurality of feeding tubes, wherein the power transmission system includes a motor and a transmission component; and the power output end of the motor is connected to the transmission component of the power input end of the transmission assembly, wherein the power output end of the transmission assembly is connected to the receiving groove and the rotating shaft, wherein the transmission of the transmission assembly drives the rotating shaft to rotate around its own axis to achieve rotation, and also drives the material receiving trough and the rotating shaft to rotate around the central axis of the mixing barrel to realize a revolving motion, wherein the sealing plate is sleeved on the top of the mixing tank, above the transmission assembly and the material receiving tank, wherein each feeding tube is worn after passing through the sealing plate, wherein the ends are respectively arranged above the material receiving troughs, and the upper ends are respectively connected with funnels.

10. The artificial quartz stone mixer according of claim 9, further comprising a powder blocking channel and a dust removing device for use during stirring, wherein airborne powder material in the mixing barrel is drawn out of the mixer through a powder blocking channel, wherein the powder blocking channel is a channel enclosed by the upper powder frame and the lower powder frame, wherein the upper powder frame includes a first upper plate, a second upper plate, and a third upper plate, wherein the first upper plate and the third upper plate are arranged vertically, wherein the second upper plate is arranged horizontally, wherein the height of the first upper plate is greater than the height of the third upper plate, wherein the second upper plate is connected to the first upper plate and the third upper plate, wherein the transmission assembly also drives the upper powder frame to rotate around the central axis of the mixing barrel, wherein the lower powder frame includes the first lower plate and the second lower board, wherein the first lower plate is arranged vertically, wherein second lower plate is arranged horizontally, wherein first lower plate is arranged between first upper plate and the third upper plate, wherein the upper powder frame does not contact the lower powder frame, wherein the second lower plate is connected to the sealing plate and to the first lower board.

11. The artificial quartz stone mixer according of claim 9, further comprising a dust removal device which comprises a dust removal device suction line that passes through the sealing plate and comprises a dust removal device intake port which is mounted over the lower plate above the second lower plate, and set between the first lower plate and the third upper plate, wherein the dust removal device is an exhaust fan or an air pump, and wherein the dust removal device filters the powder material raised in the mixing barrel and pumps it out of the mixer.

12. The artificial quartz stone mixer according of claim 1, further comprising a dust removal device which comprises a dust removal device suction line that passes through the sealing plate and comprises a dust removal device intake port which is mounted over the lower plate above the second lower plate, and set between the first lower plate and the third upper plate, wherein the dust removal device is an exhaust fan or an air pump, and wherein the dust removal device filters the powder material raised in the mixing barrel and pumps it out of the mixer.
